(19) United States
(12) Patent Application Publication
(10) Pub. No.: US 2026/0284493 A1
(43) Pub. Date: Sep. 24, 2026

(54) Impact-Damping Ring for Sports Equipment

(71) Applicant: Donovan Dreyer, San Diego, CA (US)

(72) Inventor: Donovan Dreyer, San Diego, CA (US)

(21) Appl. No.: 19/087,561

(22) Filed: Mar. 23, 2025

(51) Int. Cl. A63B 60/54; A63B 60/08; A63B 102/02; A63B 102/04; A63B 102/06; A63B 102/16; A63B 102/18; A63B 102/24; A63B 102/32; C08K 3/36; C08L 75/04; C08L 83/04

(52) U.S. Cl. CPC A63B 60/54; A63B 60/08; C08K 3/36; C08L 75/04; C08L 83/04; A63B 2102/02; A63B 2102/04; A63B 2102/06; A63B 2102/16; A63B 2102/18; A63B 2102/182; A63B 2102/24; A63B 2102/32; A63B 2209/00; C08K 2201/011; C08L 2203/14; C08L 2207/53

(57) ABSTRACT

A shock-absorbing ring is disclosed for use with sports implements, such as rackets, bats, paddles, and other impact-receiving equipment. The ring is composed of one or more materials exhibiting viscoelastic or elastomeric properties, including but not limited to thermoplastic elastomers (TPE), silicone rubber, polyurethane, ethylene vinyl acetate (EVA), and composite structures incorporating high-damping materials. The ring is configured to be positioned around or integrated within structural components of the sports implement, such as the handle, frame, or throat, to attenuate vibrational forces and dissipate impact energy upon contact. The ring comprises a multilayered construction with an inner core of a high-damping material, such as a viscoelastic foam, shear-thickening fluid, or damping gel, enclosed within a durable elastomeric shell. The outer surface may include textural enhancements or coatings to improve grip and wear resistance. The ring may be installed via friction fit, adhesive bonding, snap-fit mechanisms, or integrated molding.

### BACKGROUND OF THE INVENTION

### Field of Invention

The present invention relates to impact-damping devices, and more particularly to a shock-absorbing ring configured to reduce vibrations and dissipate impact forces in sports equipment. The invention is applicable to various sporting implements, including but not limited to rackets, bats, paddles, and other handheld or impact-receiving equipment. By mitigating vibrations transmitted through the equipment during use, the invention enhances user comfort, reduces strain, and improves overall performance.

### Brief Summary of the Invention

The present invention provides a shock-absorbing ring designed to reduce vibrations and dissipate impact forces in sports equipment. The ring is composed of an elastomeric or composite material with damping properties and is configured to be positioned on or integrated with a racket frame, bat, paddle, or other impact-receiving sports implements. Upon impact, the ring deforms to absorb and disperse vibrational energy, thereby minimizing strain on the user's hand and arm. The invention enhances comfort, improves control, and may be adapted for various sporting applications through modifications in material composition, structural design, and attachment mechanisms.

The functionality is four-fold:
Vibration damping.
Grip maximization.
Friction creation between implement handle and hand.
Increases hand feel.

### BRIEF DESCRIPTION OF THE FIGURES

FIG. 1: The installation and operation of the shock-absorbing ring involve selecting the appropriate ring based on material and size (FIG. 1.101), positioning it onto the sports implement (FIG. 1.103), securing it using the designated attachment mechanism (FIG. 1.105), ensuring proper alignment (FIG. 1.107), testing its effectiveness in vibration reduction (FIG. 1.109), making necessary adjustments or replacements (FIG. 1.111), and maintaining it for long-term durability and performance (FIG. 1.113).

FIG. 2 illustrates a bottom-up profile view of the shock-absorbing ring, showcasing its structural design and featuring a signature “M” logo embossed or molded onto the outer surface.

FIG. 3 presents a side profile view of the shock-absorbing ring, displaying its thickness, curvature, and material composition without any visible logo or markings.

### DETAILED DESCRIPTION

The present invention relates to a shock-absorbing ring designed to mitigate vibrations, dissipate impact forces, and enhance user comfort when applied to sports equipment, including but not limited to rackets, bats, paddles, and other impact-receiving implements. More particularly, the invention provides a ring-shaped structure composed of one or more materials exhibiting viscoelastic or elastomeric properties, enabling the controlled absorption and dispersion of mechanical energy generated during impact. By integrating this shock-absorbing ring onto a sports implement, the invention significantly reduces the transmission of vibrational forces to the user's hand and arm, thereby minimizing fatigue, enhancing control, and improving overall performance.

The shock-absorbing ring is configured to be installed onto or incorporated within various structural components of a sports implement, including the handle, frame, throat, or other regions subject to vibrational transmission. The ring may be designed as a continuous annular structure or as a segmented or open-ended ring that allows for adjustable installation and removal. The dimensions of the ring, including its inner diameter, outer diameter, thickness, and cross-sectional profile, may be optimized to accommodate different sporting applications, ensuring compatibility with a wide range of equipment geometries. In certain embodiments, the ring may be designed with an asymmetric or contoured profile to provide targeted damping characteristics, directing energy dissipation to specific regions of the equipment.

The invention may be manufactured using a variety of materials known for their vibration-damping properties, including but not limited to thermoplastic elastomers (TPE), silicone, natural or synthetic rubber, polyurethane, polyvinyl chloride (PVC), ethylene vinyl acetate (EVA), or composite materials incorporating both rigid and flexible components. In certain embodiments, the shock-absorbing ring may feature a multilayered construction, wherein an inner core is composed of a high-damping viscoelastic material, while an outer shell comprises a more rigid or wear-resistant material to ensure durability and longevity.

In one embodiment, the shock-absorbing ring comprises silicone rubber (polydimethylsiloxane, PDMS) with a Shore A hardness between 10 and 40, allowing for high elasticity and resistance to mechanical fatigue. PDMS exhibits excellent viscoelastic behavior, enabling it to absorb and dissipate impact forces while maintaining its structural integrity over repeated use. The damping capacity of the silicone may be enhanced by incorporating silica nanoparticle fillers (1-5% by weight) to optimize its modulus and energy dissipation characteristics.

Alternatively, the ring may be composed of thermoplastic polyurethane (TPU) with a durometer rating of 60A to 90A, which provides a balance between flexibility and durability. TPU exhibits high resistance to abrasion and tearing, making it suitable for prolonged use under high-impact conditions. The damping properties of TPU may be tailored by adjusting its polymer chain length and molecular weight distribution, with longer chains providing greater flexibility and energy absorption.

In another embodiment, the shock-absorbing ring may be constructed from a viscoelastic polyurethane foam with an open-cell structure, allowing for controlled deformation upon impact. The foam density may range from 30 to 100 kg/m³, with higher-density formulations providing enhanced damping effects. This material is particularly effective in applications requiring progressive shock absorption, as the foam compresses under load and gradually returns to its original shape, preventing sudden rebound forces.

For enhanced vibration control, the invention may incorporate a composite structure consisting of a core made from a shear-thickening fluid (STF) encased within an elastomeric shell. The STF may comprise a colloidal suspension of silica nanoparticles in polyethylene glycol (PEG) or another polymeric medium, wherein the fluid transitions from a low-viscosity state to a high-viscosity state under rapid shear forces. This behavior enables the ring to dynamically adjust its damping response based on the intensity of the impact, providing greater absorption during high-energy events.

In some embodiments, the shock-absorbing ring may include a gel-based core encapsulated within an elastomeric matrix, where the gel composition consists of dimethylsiloxane-based damping gels or hydrophilic polyacrylamide hydrogels with a water content of 30-70%. The gel-filled core deforms upon impact, redistributing mechanical energy before gradually returning to its original state, thereby minimizing residual vibrations.

The ring may be attached to the sports implement through various means, including friction fit, adhesive bonding, mechanical interlocking, or integrally molded attachment points. In embodiments where removability is desired, the ring may be equipped with an adjustable fastening mechanism, such as an overlapping clasp, hook-and-loop system, snap-fit design, or a tension-adjustable band that conforms securely to the underlying structure. Additionally, in certain embodiments, the ring may be embedded within the structure of the equipment during the manufacturing process, such as by overmolding onto the handle or frame, or by integrating it into a recess specifically designed to accommodate the damping component.

To further enhance user experience, the outer surface of the shock-absorbing ring may feature textural elements, including ridges, grooves, micro-patterns, or high-friction coatings to improve grip and tactile feedback. In embodiments where user customization is desired, the ring may be available in different stiffness levels, allowing athletes or recreational users to select an option that best suits their playing style and comfort preferences. The damping properties of the ring may be quantified in terms of its storage modulus (G′), loss modulus (G″), and damping coefficient (tan δ), which may be tailored by modifying the material composition, thickness, and structural design.

The invention may be manufactured using various processing techniques, including injection molding, compression molding, extrusion, or additive manufacturing, depending on the desired material properties and structural complexity. For composite embodiments incorporating multiple materials, co-molding or lamination techniques may be employed to ensure strong adhesion between different layers. Additionally, post-processing treatments, such as heat curing, UV stabilization, or chemical surface modification, may be applied to enhance the durability, flexibility, and environmental resistance of the ring.

When installed on a racket, bat, or other impact-receiving sports implement, the shock-absorbing ring functions by deforming upon impact, thereby absorbing and redistributing vibrational energy before it propagates through the equipment structure. The extent of vibration reduction may be quantified through frequency response analysis (FRA), modal testing, or dynamic mechanical analysis (DMA) to ensure optimal performance across a range of impact conditions. By mitigating excessive vibrations, the invention reduces strain on the user's hand, wrist, and arm, decreasing the likelihood of repetitive stress injuries and improving long-term usability.

The present invention is adaptable to a wide variety of sports applications, including but not limited to tennis rackets, badminton rackets, squash rackets, baseball bats, softball bats, table tennis paddles, golf clubs, and hockey sticks. The design of the shock-absorbing ring may be modified for each specific application by adjusting its material properties, geometric configuration, and attachment mechanism. Additionally, the invention may be used in non-sporting applications where vibration damping is required, such as in tool handles, musical instrument grips, or industrial equipment subjected to repetitive impact forces.

Accordingly, the present invention provides a highly effective and adaptable solution for reducing vibrational forces in sports equipment through a strategically designed shock-absorbing ring. By leveraging advanced material science, structural engineering, and damping technology, the invention enhances user comfort, improves performance, and extends the lifespan of the associated sporting implement. The various embodiments, materials, and configurations described herein are intended to illustrate the broad applicability of the invention and should not be construed as limiting the scope thereof.

### DETAILED DESCRIPTION OF FIGURES

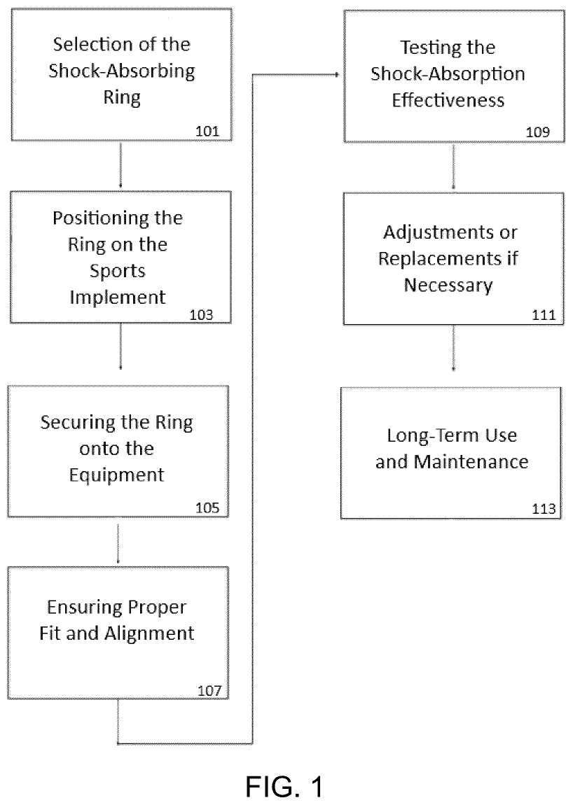

FIG. 1.101—Selection of the Shock-Absorbing Ring

The user identifies the appropriate shock-absorbing ring based on the specific sports implement and intended use. Factors such as material composition (e.g., silicone, thermoplastic elastomer, polyurethane), size, thickness, and damping properties are considered to ensure optimal vibration reduction. Rings may vary in rigidity, elasticity, or core composition (e.g., gel-filled, foam, or solid elastomer) depending on user preference and equipment specifications.

FIG. 1.103—Positioning the Ring on the Sports Implement

Once selected, the shock-absorbing ring is positioned onto the intended location of the sports implement, which may include the handle, frame, throat, or another vibrationally active region. Depending on the design, the ring may need to be stretched over the equipment, slid into place, or aligned with an integrated groove or attachment point. Proper positioning ensures maximum vibration dissipation and ergonomic benefits.

FIG. 1.105—Securing the Ring onto the Equipment

The ring is then secured onto the sports implement using the appropriate installation mechanism. In the case of friction-fit models, the ring remains in place due to its elastic tension, while snap-fit or interlocking designs may require additional pressure to lock into position. Adjustable rings may feature clasps, hook-and-loop fasteners, or tension bands for a customized fit. In some cases, adhesive bonding or overmolding may be used for permanent installation.

FIG. 1.107—Ensuring Proper Fit and Alignment

Once secured, the user verifies that the ring is correctly positioned and uniformly aligned around the equipment. The ring should maintain consistent contact with the equipment surface without excessive movement or misalignment. If the ring features textural elements or raised surfaces for grip enhancement, these should be evenly oriented to maximize performance benefits. Misalignment may reduce the effectiveness of vibration damping and comfort.

FIG. 1.109—Testing the Shock-Absorption Effectiveness

With the ring installed, the user engages in simulated or actual use of the sports implement to assess the effectiveness of vibration reduction. This may involve performing practice swings, impact tests, or direct force applications to observe changes in vibration transmission. The damping performance can be subjectively evaluated based on comfort and feedback or quantitatively measured using vibration analysis tools, frequency response tests, or force sensors.

FIG. 1.111—Adjustments or Replacements if Necessary

If the shock-absorbing ring does not provide the desired level of vibration reduction, adjustments or replacements may be performed. The user may reposition the ring to optimize placement, switch to a ring of different material composition or thickness, or install multiple rings for enhanced damping effects. In cases where degradation or excessive wear is observed, the ring may be replaced to maintain performance.

FIG. 1.113—Long-Term Use and Maintenance

For continued effectiveness, the shock-absorbing ring is maintained according to manufacturer guidelines. This may include periodic cleaning to remove debris, inspection for signs of wear or material fatigue, and proper storage to prevent environmental degradation. Rings composed of elastomeric materials may require conditioning treatments to preserve flexibility, while adhesive-mounted rings should be checked for bond integrity over time.

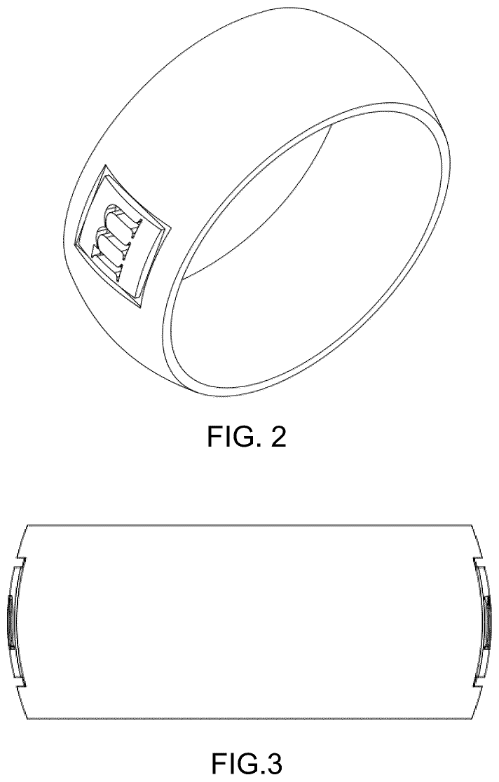

FIG. 2—Bottom-Up Profile View of the Ring with the Signature “M” Logo

FIG. 2 depicts a bottom-up profile view of the shock-absorbing ring, highlighting its circular or semi-circular geometry and the incorporation of a signature “M” logo on the outer surface. The ring may be composed of a single-layer elastomeric structure or a multi-layered composite design, depending on the selected material and intended vibration-damping properties. The “M” logo is integrated into the ring through molding, embossing, laser engraving, or surface etching, providing a distinctive brand identifier while maintaining the ring's overall structural integrity. The profile view further illustrates the thickness distribution and any internal features, such as hollow chambers, micro-perforations, or reinforcement layers, designed to enhance vibration absorption. Additionally, the outer surface may exhibit textural elements, such as ridges, grooves, or friction-enhancing patterns, to improve grip and handling. The bottom-up perspective allows for visualization of the ring's base curvature and interface with the sports implement, ensuring proper alignment and secure placement during installation.

FIG. 3—Side Profile View of the Ring (No Logo)

FIG. 3 presents a side profile view of the shock-absorbing ring, offering a detailed representation of its overall thickness, cross-sectional geometry, and material configuration. This view emphasizes the ring's height, width, and potential variations in contour, which may influence its vibration-damping performance. The absence of the “M” logo in this perspective highlights a clean, uninterrupted surface, allowing for a smooth outer texture or the incorporation of alternative grip-enhancing features. The side profile may also reveal structural reinforcements, such as internal support ribs, layered compositions, or embedded damping elements, which contribute to controlled deformation and energy dissipation upon impact. If the ring features a hollow or semi-hollow core, this view provides insight into its internal architecture, including foam inserts, gel layers, or air pockets that enhance shock absorption. The side curvature and flexibility of the ring are also depicted, ensuring compatibility with different sports implements and accommodating various attachment methods, such as friction fit, snap-fit, or adhesive bonding.

What is claimed is:

1. A shock-absorbing ring for use with a sports implement, the ring comprising:
a. a body having a continuous or segmented annular structure;
b. at least one damping material selected from the group consisting of thermoplastic elastomers (TPE), silicone rubber, natural rubber, synthetic rubber, polyurethane, ethylene vinyl acetate (EVA), polyvinyl chloride (PVC), and viscoelastic polymers; and
c. a material composition configured to deform upon impact and dissipate vibrational energy, thereby reducing the transmission of impact forces to a user's hand or arm, wherein the shock absorbing ring is configured for friction creation between the implement handle and a user's hand.

2. The shock-absorbing ring of claim 1, wherein the body is formed from a multilayered structure comprising:
a. an inner core composed of a high-damping viscoelastic material, and
b. an outer shell composed of a wear-resistant elastomer or polymer.

3. The shock-absorbing ring of claim 2, wherein the inner core comprises a viscoelastic polyurethane foam having a density of 30 to 100 kg/m³.

4. The shock-absorbing ring of claim 2, wherein the inner core comprises a shear-thickening fluid (STF) consisting of a colloidal suspension of silica nanoparticles in polyethylene glycol.

5. The shock-absorbing ring of claim 1, wherein the body is composed of silicone rubber with a Shore A hardness between 10 and 40, the silicone rubber being doped with silica nanoparticle fillers in an amount between 1% and 5% by weight.

6. The shock-absorbing ring of claim 1, wherein the body is composed of thermoplastic polyurethane (TPU) with a durometer rating between 60A and 90A.

7. The shock-absorbing ring of claim 1, wherein the body comprises an encapsulated damping gel core, the damping gel selected from dimethylsiloxane-based damping gels or polyacrylamide hydrogels with a water content of 30% to 70%.

8. The shock-absorbing ring of claim 1, wherein the body further comprises structural modifications selected from the group consisting of hollow chambers, lattice formations, micro-perforations, or textured surface patterns to enhance energy dissipation.

9. The shock-absorbing ring of claim 1, wherein the body is configured for attachment to a sports implement through an installation mechanism selected from the group consisting of:
a. friction fit;
b. adhesive bonding;
c. mechanical interlocking;
d. snap-fit attachment; and
e. tension-adjustable fastening mechanisms.

10. The shock-absorbing ring of claim 1, wherein the body is integrally molded into a sports implement during the manufacturing process.

11. The shock-absorbing ring of claim 1, wherein the body is removably attachable to a sports implement and includes an adjustable closure mechanism for secure fitting.

12. The shock-absorbing ring of claim 1, wherein the body is designed for placement around a handle, frame, throat, or impact-receiving section of a sports implement.

13. The shock-absorbing ring of claim 1, wherein the body is configured for use with sports implements selected from the group consisting of:
a. tennis rackets,
b. badminton rackets,
c. squash rackets,
d. baseball bats,
e. softball bats,
f. table tennis paddles,
g. golf clubs, and
h. hockey sticks.

14. The shock-absorbing ring of claim 1, wherein the body is further configured for use in non-sporting applications requiring vibration damping, including tool handles, musical instrument grips, and industrial equipment subject to repetitive impact forces.

15. The shock-absorbing ring of claim 1, wherein the damping properties are quantified by a storage modulus (G′), loss modulus (G″), and damping coefficient (tan δ) optimized for specific vibration frequencies associated with the intended sports implement.

16. The shock-absorbing ring of claim 1, wherein the body is manufactured using a technique selected from the group consisting of injection molding, compression molding, extrusion, additive manufacturing, co-molding, or lamination.

17. The shock-absorbing ring of claim 1, wherein the outer surface of the body includes a high-friction texture or grip-enhancing coating to improve handling and user comfort.

18. A method for reducing vibrational forces in a sports implement, the method comprising:
a. providing a shock-absorbing ring in accordance with claim 1;
b. positioning the ring onto a vibrationally active portion of the sports implement; and
c. allowing the ring to deform upon impact, thereby dissipating vibrational energy and reducing force transmission to a user's hand or arm.
